(19) United States
(12) Patent Application Publication
(10) Pub. No.: US 2022/0035140 A1
(43) Pub. Date: Feb. 3, 2022

(54) PROJECTION LENS

(71) Applicant: IVIEW DISPLAYS (SHENZHEN) COMPANY LTD., Shenzhen (CN)

(72) Inventors: Di Tan, Shenzhen (CN); Steve Yeung, Shenzhen (CN); Zhiqiang Gao, Shenzhen (CN); Yuan Zhao, Shenzhen (CN); Mingnei Ding, Shenzhen (CN)

(21) Appl. No.: 17/504,474

(22) Filed: Oct. 18, 2021

Related U.S. Application Data
(63) Continuation of application No. PCT/CN2020/125341, filed on Oct. 30, 2020.

(30) Foreign Application Priority Data
Dec. 31, 2019 (CN) 201911413700.2

(51) Int. Cl. G02B 13/16; G02B 3/04; G02B 9/64; G02B 26/08

(52) U.S. Cl. CPC G02B 13/16; G02B 26/0833; G02B 9/64; G02B 3/04

(57) ABSTRACT

A projection lens includes a display chip, an equivalent flat lens, a first refractive lens group, a diaphragm, and a second refractive lens group that are successively arranged; wherein the first refractive lens group includes a first lens and a double-cemented lens that are successively arranged, wherein the double-cemented lens includes a second lens and a third lens. A total length of the projection lens is less than 32 mm, an angle of view of the projection lens is 65 degrees, and a depth of field of the projection lens at a projection distance of 400 mm reaches ±170 mm.

### CROSS-REFERENCE TO RELATED APPLICATIONS

This application claims the benefit of and priority to PCT Patent Application No. PCT/CN2020/125341, filed Oct. 30, 2020, which is hereby incorporated by reference in its entirety.

### TECHNICAL FIELD

Embodiments of the present disclosure relate to the technical field of optics, and in particular, relate to a projector lens.

### BACKGROUND

Nowadays, with the increase in price of dwelling houses, some house buyers have to buy small houses. In this case, the widths of the sitting room, the bedroom, and the like may be small, and it is not convenient to place or install a common projector in the sitting room, and thus a poor projection effect is achieved. Therefore, projectors capable of implementing short-distance projection are well prevailing. Such projectors only need to be placed in front of a projection screen and short-distance projection is implemented.

During practice of embodiments of the present disclosure, the inventors have found that the related art has at least the following problem: a projection lens typically has a specific depth of field, but the projection distance is within a specific range; in the case that the projection distance is decreased, imaging quality of the projection lens is degraded, and the depth of field may become smaller and smaller; and during use within a short distance, quality imaging may fail once the projector is slightly moved, and user experience is thus poor.

### SUMMARY

The embodiments of the present disclosure provide a projection lens. The projection lens includes a display chip, an equivalent flat lens, a first refractive lens group, a diaphragm, and a second refractive lens group that are successively arranged;

wherein the first refractive lens group includes a first lens and a double-cemented lens that are successively arranged, wherein the double-cemented lens includes a second lens and a third lens; and the projection lens satisfies the following condition:

−170 mm≤Δ≤+170 mm

TT<32 mm

FOV=65°

wherein Δ defines a depth of field of the projection lens at a projection distance of 400 mm, TT defines a total length of the projection lens, and FOV defines an angle of view of the projection lens.

The embodiments of the present disclosure provide a projection lens. The projection lens includes a display chip, an equivalent flat lens, a first refractive lens group, a diaphragm, and a second refractive lens group that are successively arranged; wherein the first refractive lens group includes a first lens and a double-cemented lens that are successively arranged, wherein the double-cemented lens includes a second lens and a third lens. A total length of the projection lens is less than 32 mm, an angle of view of the projection lens is 65 degrees, and a depth of field of the projection lens at a projection distance of 400 mm reaches ±170 mm, such that the projection lens is capable of stably outputting sharp images during a short-range projection, and thus user experience is better.

### BRIEF DESCRIPTION OF THE DRAWINGS

One or more embodiments are illustrated by way of example, and not by limitation, in the figures of the accompanying drawings, wherein elements/modules and steps having the same reference numeral designations represent like elements/modules and steps throughout. The drawings are not to scale, unless otherwise disclosed.

FIG. 1 is a schematic diagram of an optical structure of a projection lens according to an embodiment of the present disclosure;

FIG. 2a is schematic diagram of a full-field optical modulation transfer function (MTF) of a projection lens at an ideal position according to an embodiment of the present disclosure;

FIG. 2b is schematic diagram of a full-field optical MTF of a projection lens at a foreground position according to an embodiment of the present disclosure;

FIG. 2c is schematic diagram of a full-field optical MTF of a projection lens at a background position according to an embodiment of the present disclosure;

FIG. 3a is a schematic diagram of distortion and field curvature of full-field optical and full wave-band of a projection lens at an ideal position according to an embodiment of the present disclosure;

FIG. 3b is a schematic diagram of distortion and field curvature of full-field optical and full wave-band of a projection lens at a foreground position according to an embodiment of the present disclosure;

FIG. 3c is a schematic diagram of distortion and field curvature of full-field optical and full wave-band of a projection lens at a background position according to an embodiment of the present disclosure;

FIG. 4a is a schematic diagram of vertical chromatic aberration in full-field optical of a projection lens at an ideal position according to an embodiment of the present disclosure;

FIG. 4b is a schematic diagram of vertical chromatic aberration in full-field optical of a projection lens at a foreground position according to an embodiment of the present disclosure;

FIG. 4c is a schematic diagram of vertical chromatic aberration in full-field optical of a projection lens at a background position according to an embodiment of the present disclosure;

FIG. 5a is a schematic diagram of dot columns in full-field optical of a projection lens at an ideal position according to an embodiment of the present disclosure;

FIG. 5b is a schematic diagram of dot columns in full-field optical of a projection lens at a foreground position according to an embodiment of the present disclosure; and

FIG. 5c is a schematic diagram of dot columns in full-field optical of a projection lens at a background position according to an embodiment of the present disclosure.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure.

It should be noted that, in the absence of conflict, embodiments of the present disclosure and features in the embodiments may be incorporated, which all fall within the protection scope of the present disclosure. In addition, although function module division is illustrated in the schematic diagrams of apparatuses, and in some occasions, module division different from the divisions of the modules in the apparatuses may be used. Further, the terms “first,” “second,” and the like used in this text do not limit data and execution sequences, and are intended to distinguish identical items or similar items having substantially the same functions and effects.

For ease of definition of the connection structure, the positions of the components are defined using the direction of light path traveling/optical axis as a reference. For example, the direction of light, emitted from a display chip and passing through a first refractive lens group 30, is the “front” direction, the direction of a light path emitted from a diaphragm 40 is the “horizontal” direction, and the diaphragm 40 is on the “left” side/edge of the first refractive lens group 30.

Unless the context clearly requires otherwise, throughout the specification and the claims, technical and scientific terms used herein denote the meaning as commonly understood by a person skilled in the art. Additionally, the terms used in the specification of the present disclosure are merely for description the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

Specifically, hereinafter, the embodiments of the present disclosure are further illustrated with reference to the accompanying drawings.

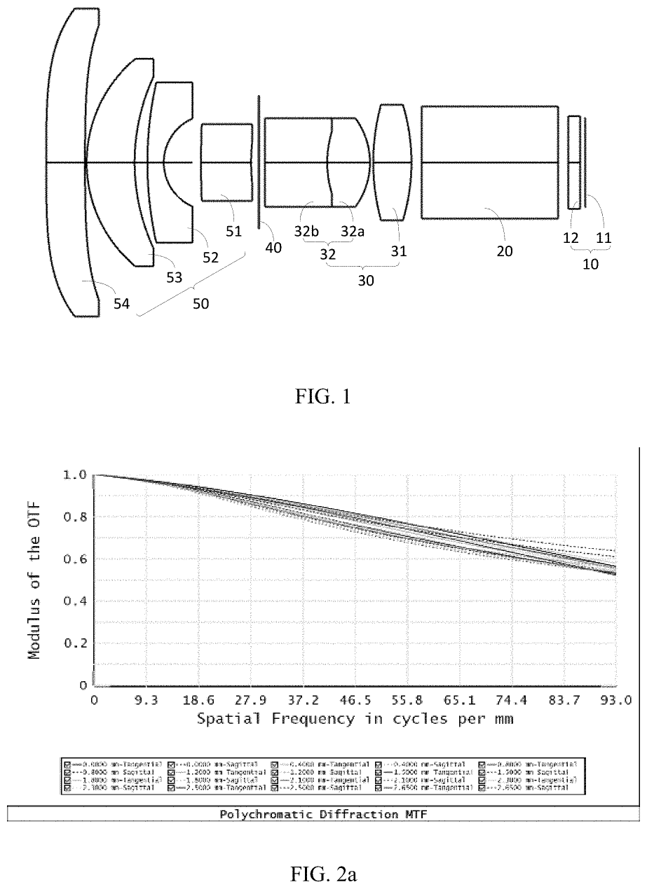

Referring to FIG. 1, a schematic diagram of an optical structure of a projection lens according to an embodiment of the present disclosure is illustrated. The projection lens includes a display chip 10, an equivalent flat lens 20, a first refractive lens group 30, a diaphragm 40, and a second refractive lens group 50 that are successively arranged; wherein the first refractive lens group 30 includes a first lens 31 and a double-cemented lens 32 that are successively arranged, wherein the double-cemented lens 32 includes a second lens 32a and a third lens 32b. The projection lens satisfies the following condition:

−170 mm≤Δ≤+170 mm

TT<32 mm

FOV=65°

wherein Δ represents a depth of field of the projection lens at a projection distance of 400 mm, TT represents a total length of the projection lens, and FOV represents field of view of the projection lens.

The embodiments of the present disclosure provide a projection lens. The projection lens includes a display chip 10, an equivalent flat lens 20, a first refractive lens group 30, a diaphragm 40, and a second refractive lens group 50 that are successively arranged; wherein the first refractive lens group 30 includes a first lens 31 and a double-cemented lens 32 that are successively arranged, wherein the double-cemented lens 32 includes a second lens 32a and a third lens 32b. A total length of the projection lens is less than 32 mm, an angle of view of the projection lens is 65 degrees, and a depth of field of the projection lens at a projection distance of 400 mm reaches ±170 mm, such that the projection lens is capable of stably outputting sharp images during a short-distance projection, and thus user experience is better.

In an embodiment of the present disclosure, the display chip 10 includes an effective surface 11 and a projective glass 12 proximal to the first lens 31. The display chip 10 is a DMD chip, and preferably, is a 0.2 DMD chip. The display chip 10 is configured to process an image signal, and generate an image beam. The image beam, as illustrated in FIG. 1, is emitted towards left, and passes through the equivalent flat lens 20, the first refractive lens group 30, the diaphragm 40, and the second refractive lens group 50, and images are displayed on a display screen (not illustrated). The display chip 10, the equivalent flat lens 20, the first refractive lens group 30, the diaphragm 40, and the second refractive lens group 50 are arranged on the same optical axis.

In an embodiment of the present disclosure, the equivalent flat lens 20 is a total internal reflection (TIR) lens equivalent to a flat, and is configured to reach a state of a light ray in a prism to deflect the light ray, and separate an illumination light path from an imaging light path to avoid interference.

In an embodiment of the present disclosure, the first lens 31 is a biconvex glass lens, and has a positive focal power, and a focal length satisfying 6 mm<|f₁|<8 mm. The double-cemented lens 32 has a positive focal power, wherein the second lens 32a is a biconvex glass lens, and has a positive focal power, and a focal length satisfying 5 mm<|f₃|<7 mm; and the third lens 32b is a plano-concave glass lens, and has a negative focal power, a focal length satisfying 5 mm<|f₃|<7 mm, and a plano surface facing towards the diaphragm 40.

In an embodiment of the present disclosure, the second refractive lens group 50 includes a fourth lens 51, a fifth lens 52, a sixth lens 53, and a seventh lens 54 that are successively arranged.

The fourth lens 51 is a meniscus thick lens, and has a negative focal power, a focal length satisfying 25 mm<|f₄|<30 mm, and a concave surface facing towards the diaphragm 40. The fifth lens 52 is a meniscus glass lens, and has a negative focal power, a focal length satisfying 5 mm<|f₅|<7 mm, and a concave surface facing towards the diaphragm 40. The sixth lens 53 is a meniscus glass lens, and has a negative focal power, a focal length satisfying 18 mm<|f₆|<22 mm, and a concave surface facing towards the diaphragm 40. The seventh lens 54 is a meniscus glass aspherical lens, and has a negative focal power, a focal length satisfying 550 mm<|f₇|<600 mm, and a concave surface facing towards the diaphragm 40. It should be noted that, in an embodiment of the present disclosure, the seventh lens 54 finally emitting light rays are made of glass, and this prevents the lens from film cracking and film peeling off during wiping the lens.

During practical design for the projection lens according to the embodiments of the present disclosure, the display chip 10 with an acceptable maximum spot size (resolution and pixel pitch) of 2 pitches is selected, the number of Fs in the system is selected as 3, and a 0.2 DMD chip is selected. In this way, an acquired optical total length of the projection lens is controlled to be less than 32 mm, an effective focal length of the projection lens is 4.16 mm, a back focal length of the projection lens (that is, a distance from the left side of the seventh lens 54 to the effective surface 11 of the display chip 10) is 31.59 mm, a length of the equivalent flat lens 20 is 8 mm, a length of the lens group (that is, a distance from the left side of the seventh lens 54 to the right side of the first lens 31) is 21.4 mm, and a maximum diameter of the projection lens (that is, a diameter of the seventh lens 54) is 18.2 mm.

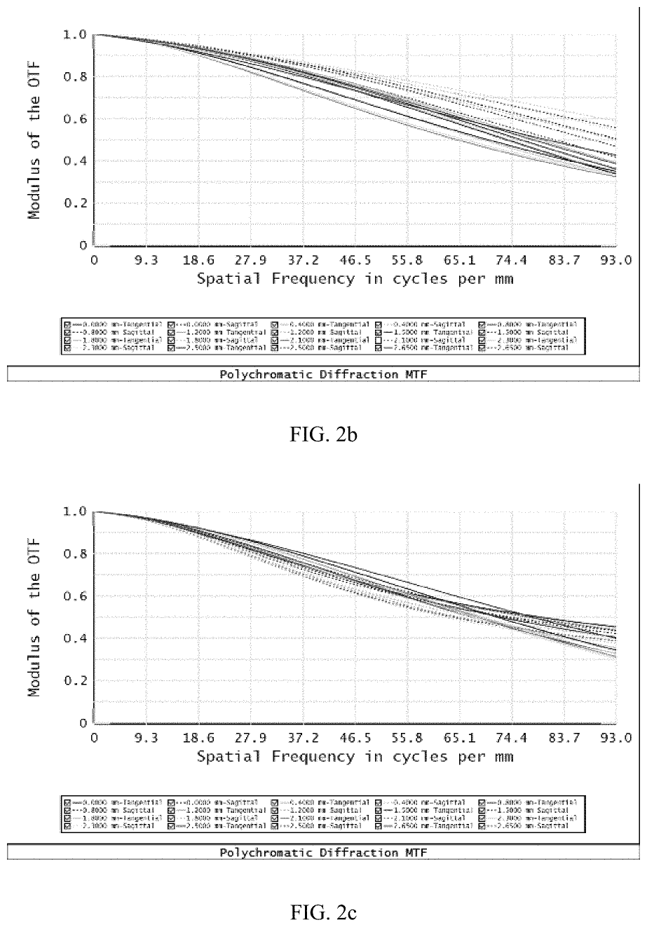

Based on the projection lens as illustrated in FIG. 1 and the actual design parameters of the projection lens, an imaging quality diagram capable of characterizing the projection lens in the full field and full wave-band as illustrated in FIG. 2 to FIG. 5 in the projection system may be acquired.

FIG. 2a is schematic diagram of a full-field optical modulation transfer function (MTF) of a projection lens at an ideal position according to an embodiment of the present disclosure, wherein the ideal position is a projection distance of 400 mm, and as illustrated in FIG. 2a, with the Nyquist frequency (at a spatial frequency of 93 lp/mm) of the projection lens, the full-field optical modulation transfer function (MTF) is greater than 50%, which is high.

FIG. 2b is schematic diagram of a full-field modulation transfer function (MTF) of a projection lens at a foreground position according to an embodiment of the present disclosure, wherein the foreground position is a projection distance of 230 mm, and as illustrated in FIG. 2b, with the Nyquist frequency (at a spatial frequency of 93 lp/mm) of the projection lens, and the-full field optical modulation transfer function (MTF) is greater than 30%, which is high.

FIG. 2c is schematic diagram of a full-field optical modulation transfer function (MTF) of a projection lens at a background position according to an embodiment of the present disclosure, wherein the background position is a projection distance of 570 mm, and as illustrated in FIG. 2c, with the Nyquist frequency (at a spatial frequency of 93 lp/mm) of the projection lens, and the full-field optical modulation transfer function (MTF) is greater than 30%, which is high.

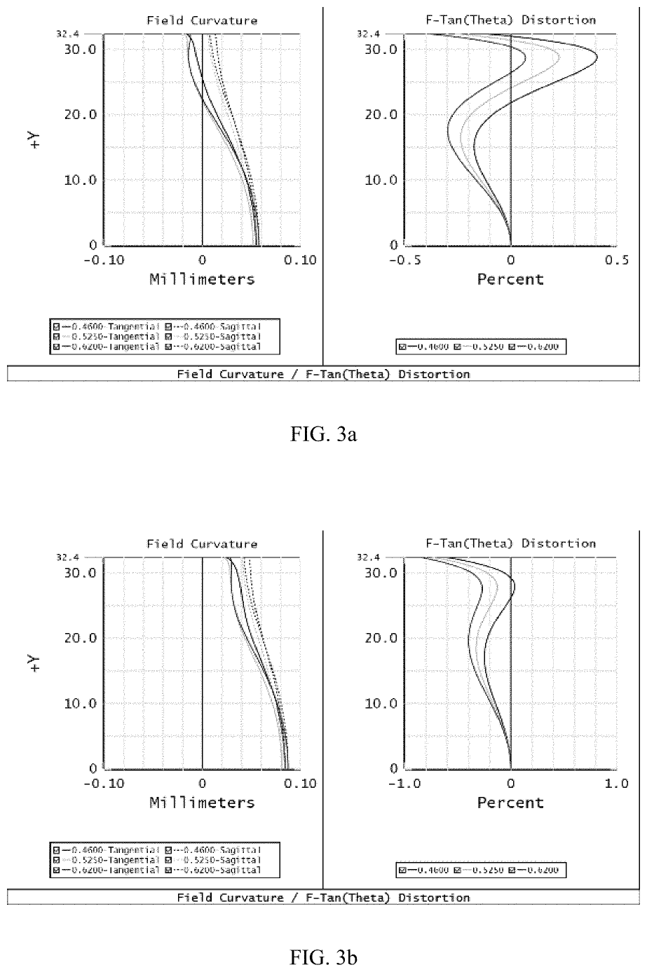

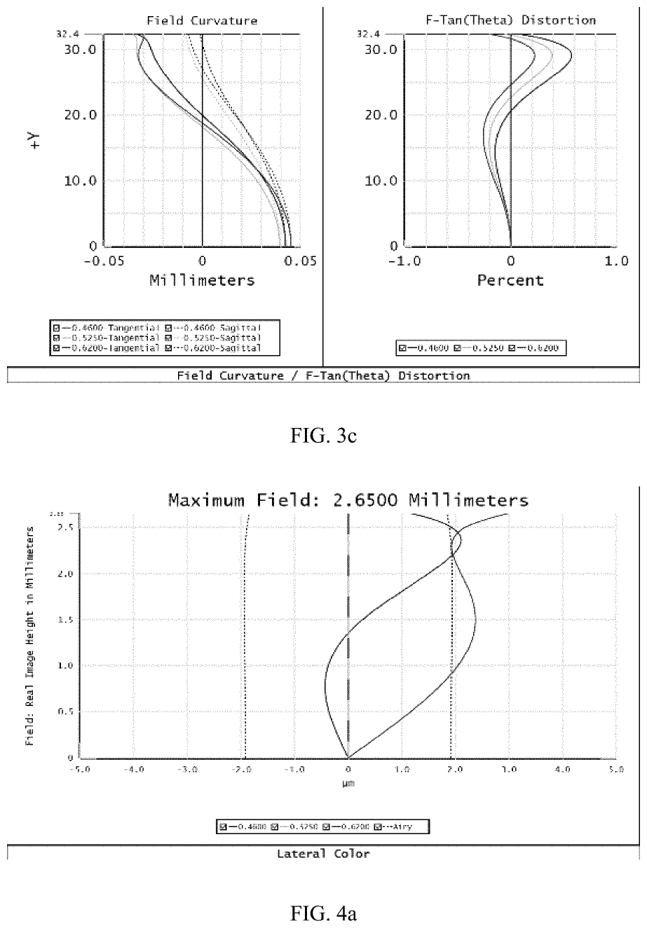

FIG. 3a is a schematic diagram of distortion and field curvature of a full field optical and full wave band of a projection lens at an ideal position according to an embodiment of the present disclosure, wherein the ideal position is a projection distance of 400 mm, the left part illustrates the field curvature, and the right part illustrates the distortion. As illustrated in FIG. 3a, the field curvature of the projection lens is controlled to be less than 0.1 mm, and the distortion is controlled to be less than 0.5%; therefore, images projected at the projection distance of 400 mm has a higher definition and smaller distortion.

FIG. 3b is a schematic diagram of distortion and field curvature of a full-field optical and full wave band of a projection lens at a foreground position according to an embodiment of the present disclosure, wherein the foreground position is a projection distance of 230 mm, the left part illustrates the field curvature, and the right part illustrates the distortion. As illustrated in FIG. 3b, the field curvature of the projection lens is controlled to be less than 0.1 mm, and the distortion is controlled to be less than 1%; therefore, images projected at the projection distance of 230 mm has a higher definition and smaller distortion.

FIG. 3c is a schematic diagram of distortion and field curvature of a full-field optical and full wave band of a projection lens at a background position according to an embodiment of the present disclosure, wherein the background position is a projection distance of 570 mm, the left part illustrates the field curvature, and the right part illustrates the distortion. As illustrated in FIG. 3c, the field curvature of the projection lens is controlled to be less than 0.05 mm, and the distortion is controlled to be less than 1%; therefore, images projected at the projection distance of 570 mm has a higher definition and smaller distortion.

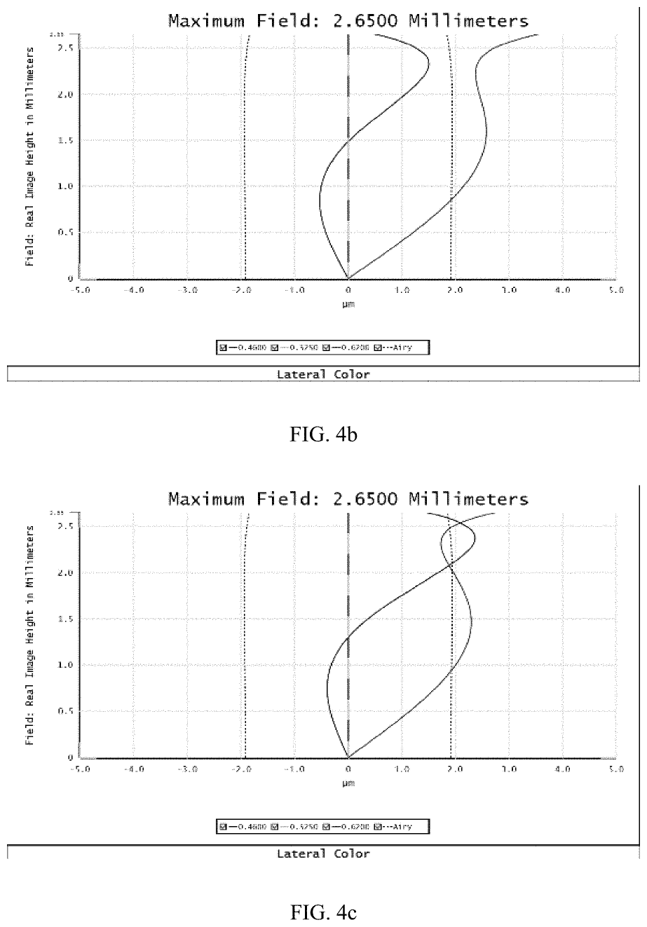

FIG. 4a is a schematic diagram of vertical chromatic aberration in full-field optical of a projection lens at an ideal position according to an embodiment of the present disclosure, wherein the ideal position is a projection distance of 400 mm, and as illustrated in FIG. 4a, the vertical chromatic aberration of the projection lens is not greater than 3 μm.

FIG. 4b is a schematic diagram of vertical chromatic aberration in full-field optical of a projection lens at a foreground position according to an embodiment of the present disclosure, wherein the foreground position is a projection distance of 230 mm, and as illustrated in FIG. 4b, the vertical chromatic aberration of the projection lens is not greater than 4 μm.

FIG. 4c is a schematic diagram of vertical chromatic aberration in full-field optical of a projection lens at a background position according to an embodiment of the present disclosure, wherein the background position is a projection distance of 570 mm, and as illustrated in FIG. 4c, the vertical chromatic aberration of the projection lens is not greater than 3 μm.

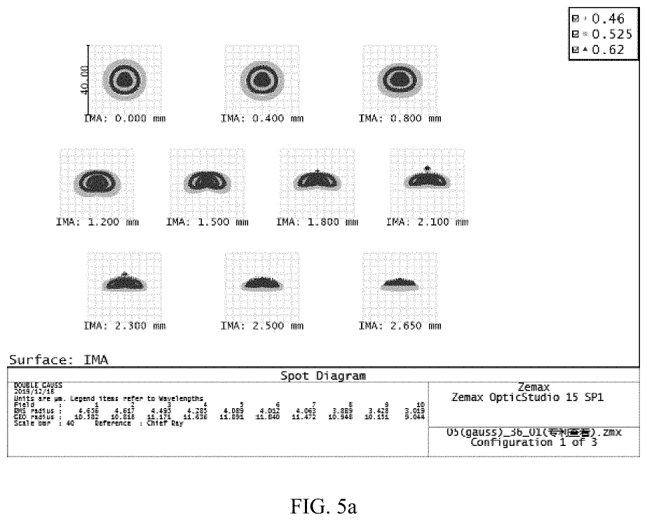

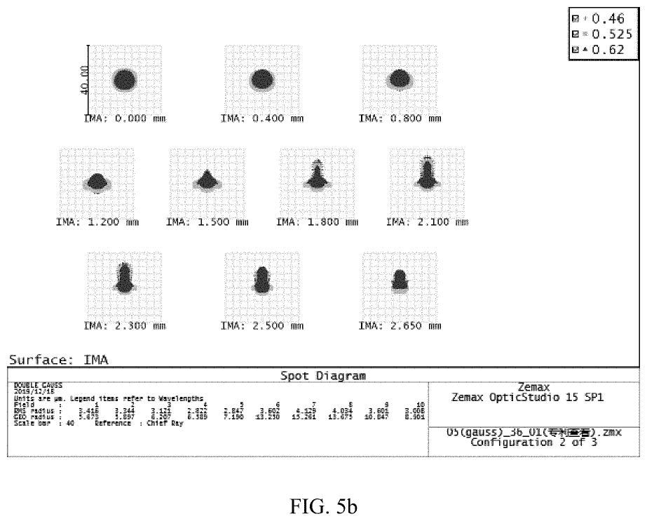

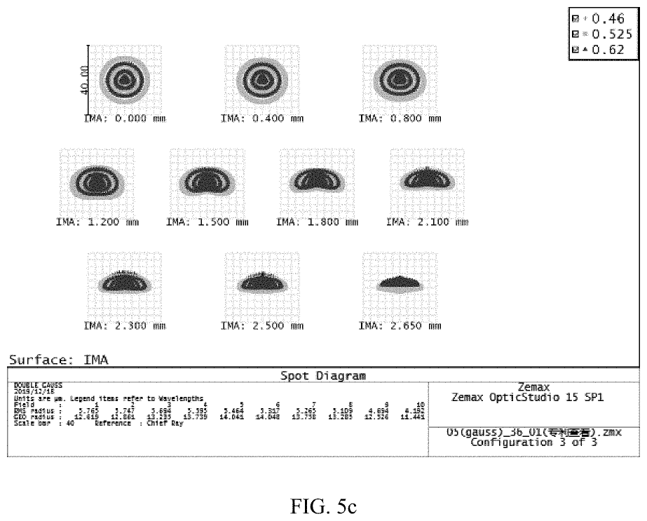

FIG. 5a is a schematic diagram of dot columns in full-field optical of a projection lens at an ideal position according to an embodiment of the present disclosure, wherein the ideal position is a projection distance of 400 mm, and as illustrated in FIG. 5a, an RMS radius of the projection lens is not greater than 5 μm.

FIG. 5b is a schematic diagram of dot columns in full-field optical of a projection lens at a foreground position according to an embodiment of the present disclosure, wherein the foreground position is a projection distance of 230 mm, and as illustrated in FIG. 5b, an RMS radius of the projection lens is not greater than 5 μm.

FIG. 5c is a schematic diagram of dot columns in full-field optical of a projection lens at a background position according to an embodiment of the present disclosure, wherein the background position is a projection distance of 570 mm, and as illustrated in FIG. 5c, an RMS radius of the projection lens is not greater than 6 μm.

The embodiments of the present disclosure provide a projection lens. The projection lens includes a display chip, an equivalent flat lens, a first refractive lens group, a diaphragm, and a second refractive lens group that are successively arranged; wherein the first refractive lens group includes a first lens and a double-cemented lens that are successively arranged, wherein the double-cemented lens includes a second lens and a third lens. A total length of the projection lens is less than 32 mm, an angle of view of the projection lens is 65 degrees, and a depth of field of the projection lens at a projection distance of 400 mm reaches ±170 mm, such that the projection lens is capable of stably outputting sharp images during a short-distance projection, and thus user experience is better.

It should be noted that the above described device embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objectives of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A projection lens, comprising: a display chip, an equivalent flat lens, a first refractive lens group, a diaphragm, and a second refractive lens group that are successively arranged;
wherein the first refractive lens group comprises a first lens and a double-cemented lens that are successively arranged, wherein the double-cemented lens comprises a second lens and a third lens; and the projection lens satisfies the following condition:
−170 mm≤Δ≤+170 mm
TT<32 mm
FOV=65°
wherein Δ defines a depth of field of the projection lens at a projection distance of 400 mm, TT defines a total length of the projection lens, and FOV defines an angle of view of the projection lens.

2. The projection lens according to claim 1, wherein the first lens is a biconvex glass lens with positive focal power, and a focal length range of the first lens is 6 mm<|f₁|<8 mm.

3. The projection lens according to claim 2, wherein
the double-cemented lens with positive focal power,
the second lens is a biconvex glass lens with positive focal power, and a focal length range of the second lens is 5 mm<|f₂|<7 mm; and
the third lens is a plano-concave glass lens with negative focal power, and a focal length range of the third lens is 5 mm<|f₃|<7 mm;
the plano surface of the third lens facing towards the diaphragm.

4. The projection lens according to claim 1, wherein the second refractive lens group comprises a fourth lens, a fifth lens, a sixth lens, and a seventh lens that are successively arranged.

5. The projection lens according to claim 4, wherein the fourth lens is a meniscus thick lens with negative focal power, and a focal length range of the fourth lens is 25 mm<|f₄|<30 mm;
the concave surface of the fourth lens facing towards the diaphragm.

6. The projection lens according to claim 4, wherein the fifth lens is a meniscus glass lens with negative focal power, and a focal length range of the fifth lens is 5 mm<|f₅|<7 mm, the concave surface of the fifth lens facing towards the diaphragm.

7. The projection lens according to claim 4, wherein the sixth lens is a meniscus glass lens with negative focal power, a focal length range of the sixth lens is 18 mm<|f₆|<22 mm, the concave surface of the sixth lens facing towards the diaphragm.

8. The projection lens according to claim 4, wherein the seventh lens is a meniscus glass aspherical lens with negative focal power, a focal length range of the seventh lens is 550 mm<|f₇|<600 mm, the concave surface of the seventh lens facing towards the diaphragm.

9. The projection lens according to claim 1, wherein the display chip comprises an effective surface and a projective glass proximal to the first lens.

10. The projection lens according to claim 9, wherein the display chip is a digital micromirror devices (DMD) chip.
